(19) United States
(12) Patent Application Publication
(10) Pub. No.: US 2003/0126711 A1
(43) Pub. Date: Jul. 10, 2003

(54) Paint roller frame with accessories

(76) Inventor: Lev Korenevsky, Miami, FL (US)

Correspondence Address: LEV KORENEVSKY, 250 174st. #1107, MIAMI BEACH, FL, 33160, US

(21) Appl. No.: 10/037,548

(22) Filed: Jan. 4, 2002

(51) Int. Cl. B05C 17/10

(52) U.S. Cl. 15/230.11; 15/144.3; 15/144.4; 15/142; 15/236.03; 492/13; 492/19

(57) ABSTRACT

A paint roller frame with a cage assembly rotatably mounted on a shaft portion of the roller frame, which is used with a replaceable paint roller sleeve, and accessories useful when working with the paint roller frame. The cage assembly is designed to securely retain a paint roller sleeve and to eliminate leakage of paint into the interior of the roller sleeve core. The roller cage assembly comprises the bearing portion and the outer portion which is removable to permit replacement of the roller sleeve. The bearing portion has the roller sleeve supporting surface and the inner annular face to be urged against the inner end of the sleeve core. The outer portion has the cylinder surface to support the outer end of the sleeve and the outer annular face to be urged against the outer end of the sleeve core. Such design of the roller cage assembly prevents the roller sleeve from axial sliding, inhibits paint flow into the core interior, and allows to use paint roller sleeves of at least two standard lengths with the same roller frame. The roller frame can be complemented with a permanent or a clip-on hook to position the roller frame on a grid in the highest possible position that allows to pour more paint in a paint bucket without the paint roller sleeve soaking the paint. A clip-on end wig can be mounted on the annular outer face to effectively paint corners. Plastic sheathing of a portion of the shaft and an enhanced shaft shape improve the paint roller frame performance. The multi-purpose painter tool can be used to extract paint from a paint roller sleeve and a brush, to grip the roller sleeve retaining the roller cage from rotation while disconnecting the outer portion from the bearing portion. The tool can be also used to widen wall cracks before sealing them with plaster. A handle adapter allows to instantly attach an extension pole to a paint roller frame handle and disconnect it as needed without screwing and unscrewing. A paint bucket organizer for a standard 5-gallon bucket has a means to retain a grid in a proper position inside the bucket and support the roller frame handle when the frame is hanging on the grid, which is especially important when an extension pole is attached to the handle. An attachable brush and tools container can be placed on the paint bucket, the paint bucket organizer, or attached to the painter's belt.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

1. Field of the Invention

The present invention relates generally to paint roller frames and accessories used together with paint roller frames.

2. Discussion of the Prior Art

One objective of this invention is to retain the paint roller sleeve from axial sliding and to inhibit paint flow into the core and roller cage interior. The sleeve retention and leakage prevention problem is solved in the prior art either by imposing a significant frictional engagement between the supporting structures of the roller cage and the inner surface of the sleeve core or by using a retainer that must be removed from the roller sleeve's way when the sleeve is mounted on and taken from the roller cage.

The first method with, for example, a wire cage structure for retention, is more popular in common use. Examples of such prior art are disclosed in U.S. Pat. No. 5,345,648, U.S. Pat. No. 5,167,055, and U.S. Pat. No. 3,119,137. This method provides a convenience of fast mounting and removal, but does not guarantee a reliable retention and elimination of paint flow inside the roller cage. When a paint roller sleeve is sliding during painting, painters are usually taping on it to return in the proper working position.

The second method requires some sophistication in the roller cage design, but works fine for retention and with more or less success in preventing paint leaks inside the cage. Examples of this method are disclosed in U.S. Pat. No. 5,594,971 and U.S. Pat. No. 4,467,509. The best results in inhibiting paint flow in-between the roller cage ends and the sleeve core are achieved when both sleeve core ends are sealed with annular faces that are urged against the core and the squeeze does not weaken during painting (the outer annular face for such designs is removable). Nevertheless, the paint roller frame designs that implement such approach and provide annular outer faces are not sufficient to completely eliminate paint leakage. The reason is slight deviations in the sleeve core's dimensions: not a precise uniform inner diameter and length and the core end unevenness. None of those designs also addresses the difficulty of retaining the roller cage from rotation when the removable outer face must be unscrewed and taken away.

Another problem that is considered in patents dealing with paint roller frames is usage of the same roller frame with sleeves of various lengths as, for example, U.S. Pat. No. 3,745,624 and U.S. Pat. No. 4,316,301. Uniformity of the roller frame in such designs, which is based on the frictional engagement of the sleeve with the supporting roller cage structure, is not reliable and can be broken during painting. A further objective of this invention is to allow adjusting the leak-proof roller frame to accommodate paint roller sleeves of at least two standard lengths, for example, most popular 9″ and 7″, and intermediate lengths.

For any roller frame design, certain parts of the roller cage become imperfect after some period of exploitation while most roller frame details are not worn out. In particular, washers and bearings or bushings are more vulnerable than other parts. Ability of the leak-proof adjustable roller frame to be easily disassembled for maintenance and replacement of worn parts is another objective of this invention. According to our knowledge, no previous art addressed the problem of roller cage worn parts replacement.

Therefore, the objective of this invention are to develop a paint roller frame design that

would be leak-proof

would allow for the same roller frame be used with paint roller sleeves of at least two standard lengths and intermediate lengths

would permit the roller cage be easily disassembled for maintenance or replacement of worn parts, assembled again, and mounted back on the shaft of the roller frame.

During the periods of non-use, when working with a standard 5-gallon paint bucket, the roller frame is traditionally resting on a grid with the help of a hook provided by the roller frame handle or located close to it on the shaft's handle portion. In this position the roller sleeve is deep inside the bucket.

Painters would prefer to pour as much paint in the paint bucket as possible. But when the paint bucket contains more than two gallons of paint, the paint covers a portion of the resting paint roller sleeve. As a result, the sleeve soaks the paint, which creates a definite inconvenience for the painter. To avoid this, the painter keeps not more than two gallons of paint in the paint bucket. It also becomes inconvenient to work when paint is consumed and is below certain level. Consequently, the painter frequently adds paint, which is a certain nuisance for him. According to our knowledge, this problem is not addressed in the previous art, while a number of patents discuss, for example, paint roller support when the paint roller frame is resting on the paint tray, in particular U.S. Pat. No. 3,087,190 and U.S. Pat. No. 4,025,205. Another objective of this invention is to keep the paint roller sleeve in a higher position while the roller frame is resting on the grid mounted on the 5-gallon paint bucket. This would allow having more paint in the paint bucket while the roller sleeve is still above the paint surface and, therefore, the painter would be adding paint to the bucket less often.

Painting of corners is a typical situation when a conventional roller frame is to be complemented with a brush to do the job including cases when both contacting surfaces are to be painted with the same paint. End caps with painting portions made of a material similar to the covering of roller sleeves that are used for painting in corners are discussed in many patents and differ mostly in methods they are attached to the roller cage assembly as it is disclosed, for example, in U.S. Pat. No. 6,185,780 and U.S. Pat. No. 5,163,264. One more objective of this invention is a new design of such a cap, the roller end wig, to work together with the proposed new design of the roller cage.

There are two frequently experienced problems while operating roller frames, which are related to the frame's shaft. First problem is that every time a metal shaft is touching the wall it leaves a dark spot, especially when flat paint is used. The shaft portion that causes such marks is adjacent and perpendicular to the roller cage. Another problem exists for the shaft of a conventional shape that has a 90° outer corner between the shaft portion adjacent to the roller cage and the shaft portion that is parallel to the roller cage axle. Such shape causes certain inconveniences when the painter is operating in narrow places. According to our knowledge, both problems are not addressed in the previous art. One more objective of this invention is to eliminate these shaft-related problems.

Handling paint roller sleeves requires such operations as removal of the paint roller sleeve from the roller cage and extracting paint off the sleeve before its removal. The tools for such operations are discussed, for example, in U.S. Pat. No. 5,832,557, U.S. Pat. No. 5,272,782, and U.S. Pat. No. 2,961,683. Some tools, in addition, can be used to clean brushes. Another objective of this invention is a convenient multi-purpose tool that is able to perform these operations, while being of compact and simple design that also comprises other tools useful for painters. The tool allows imposing a desirable controlled pressure on the embraced surface to extract paint from the paint roller sleeve. It can be used to remove the paint roller sleeve from the roller cage of a conventional design. The tool has combs with differently spaced teeth to remove paint from brushes and a crack widener.

One more objective of this invention is to create a handle adapter that would allow instant connection and disconnection of any conventional paint roller frame and extension pole while providing a reliable and firm connection without screwing and unscrewing. According to our knowledge, this problem was not addressed in the previous art, though several patents were devoted to angularly adjustable adapters for paint rollers, in particular, U.S. Pat. No. 5,050,261 and U.S. Pat. No. 3,866,257.

When painters are working with a conventional 5-gallon paint bucket using a paint-draining grid to remove extra paint from the roller sleeve, the grid is sliding along the bucket upper rim. If it slides along the bucket upper rim the bucket becomes unbalanced if lifted. When as a result of sliding the grid crosses the line of the paint bucket handle, the grid with a paint roller frame hanging on it becomes an obstacle when the handle must be used to lift the paint bucket and this becomes a nuisance for the painter. Another problem is that the roller frame hanging on the grid is very unstable when an extension pole is attached to its handle. According to our knowledge, both problems are not addressed in the previous art. Elimination of these problems with the help of a paint bucket organizer is another objective of this invention.

When painting walls by a paint roller frame, the painter from time to time needs a brush. It should be conveniently kept nearby while not in use and would be better used with a small container with paint while painting. U.S. Pat. No. 4,436,217, for example, describes a brush support that can be placed in a small paint bucket and U.S. Pat. No. 4,325,503 shows how such a small paint bucket can be held on the painter's belt. Another objective of this invention is a convenient container that can keep a brush, some paint, and several tools that are periodically needed while painting. This container can be attached to a conventional 5-gallon paint bucket and has means to be attached to the painter's belt or belt loops.

### SUMMARY OF THE INVENTION

The present invention features a paint roller and several accessories helpful for the painters that paint with paint roller frames. The invented paint roller frame firmly retains a removable paint roller sleeve in the working position and does not let any paint to leak inside the sleeve core and the roller cage. This is achieved through several innovations. One of the most important features of the new design is a detachable outer portion of the roller cage assembly that combines the cylinder surface to support the outer end of the roller sleeve and the outer retaining face. This outer portion is attached to the bearing portion of the roller cage assembly by such locking means that allow imposing a desirable squeeze of the sleeve core. Two resilient washers adjacent to both inner and outer sleeve core edges are one more element that further improves leak-proof characteristics of the roller cage assembly. They absorb the core end unevenness and help to impose a stable urge on the core. The third key component of the invention is represented by an external washer for the bearing assembly which block another possible route of paint inside the roller cage: in-between the bearing assembly and the shaft. Usage of the removable outer portion creates preconditions for a design that allows the same roller frame be used with roller sleeves of at least two standard lengths and intermediate lengths.

The invention provides a paint roller frame design in which the roller cage is easily disassembled for maintenance and replacement of worn washers and bushings, assembled again, and mounted on the shaft with the help of conventional tools.

A roller cage stopper can be added to the roller frame design for a convenient way of retaining the roller cage from rotation when a roller sleeve has to be mounted on or taken off the roller cage and the outer portion must be screwed on or out of the bearing portion of the roller frame.

A multi-purpose paint tool was invented to be used with paint roller frames of all designs for extracting paint from the paint roller sleeve before it is removed from the roller cage, removing paint from and cleaning brushes, and other usages like wall crack widening.

The cylinder surface of the outer annular face of the detachable outer portion provides preconditions for a new design of a clip-on end wig. When both walls of a corner are to be painted, the wig allows painting without complementing the paint roller frame with a brush.

A permanent hook located on the shaft close to the roller cage allows keeping the roller frame in the highest possible position above the paint surface when the roller frame is resting on a grid placed in a paint bucket. As a result, the painter is adding more paint to the bucket (and less often!) without the paint roller sleeve soaking the paint. Attaching a similar clip-on hook can modify any conventional paint roller frame to achieve the same result.

A plastic sheathing for the portion of the shaft adjoining the roller cage assembly eliminates creation of dark marks when this shaft portion occasionally touches the wall (the marks are more visible when a flat paint is used.) Smoothening of the 90° angle between the shaft portion adjacent to the roller cage and the shaft portion parallel to the roller axle results in more convenient work when the roller frame is used in narrow places.

A handle adapter that allows an instant attachment/detachment of an extension pole to/from the paint roller frame as needed without screwing and unscrewing. It provides a reliable and firm connection between the paint roller frame handle and the extension pole.

A paint bucket organizer can be fixed at a standard 5-gallon bucket. It has a means to retain a grid in a proper position across the bucket handle and supports the roller frame handle when the frame is hanging on the grid, which is especially important when an extension pole is attached to the handle.

An attachable brush and tools container can be placed on the paint bucket or the paint bucket organizer. It can be also taken from the paint bucket and attached to the painter's belt when it is more convenient for the painter to use a small paint container to paint some sections of the wall by a brush.

### BRIEF DESCRIPTION OF THE DROWINGS

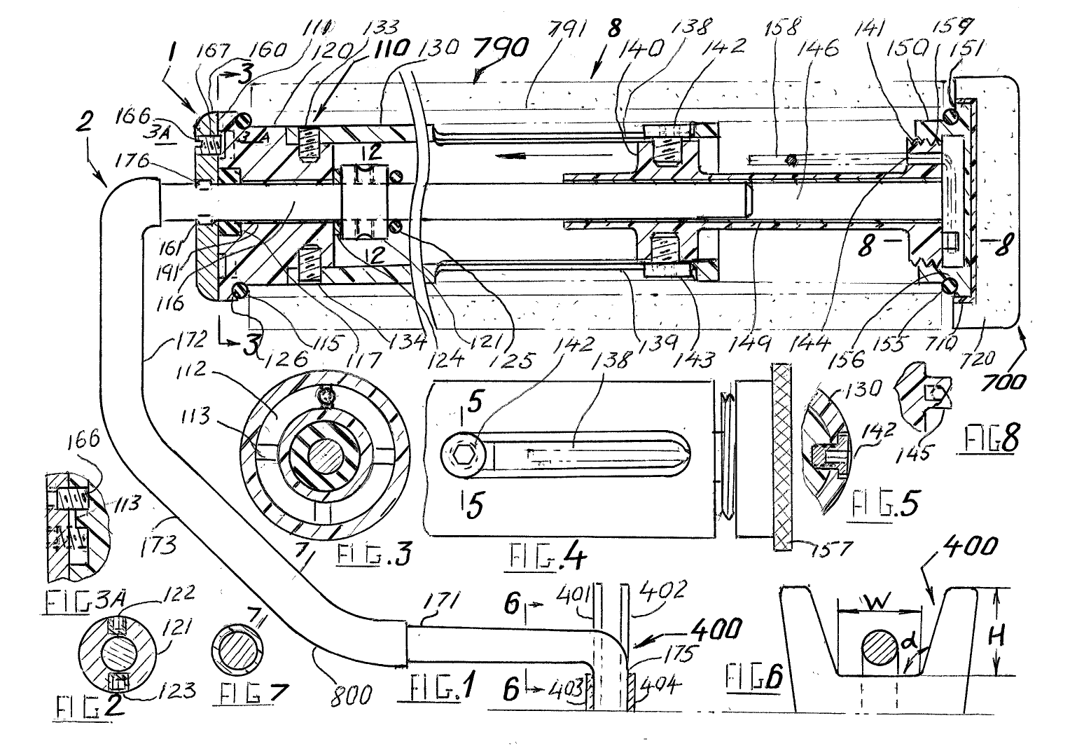

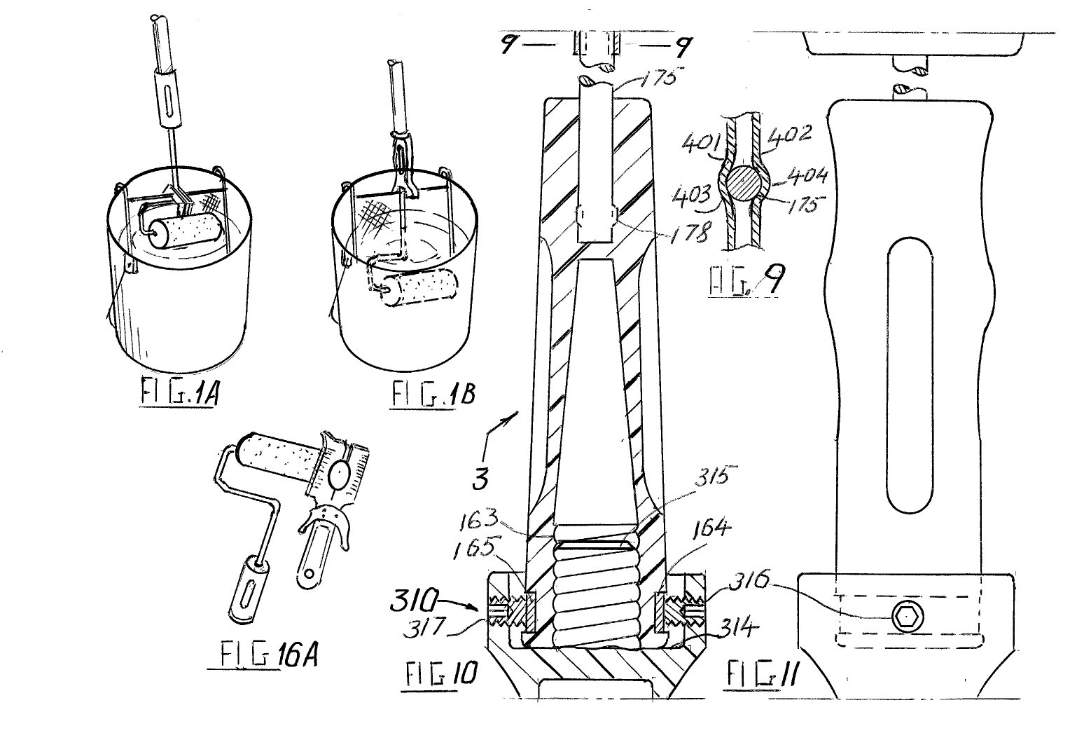

FIG. 1 is a fragmentary side cross sectional view of the first preferred embodiment of the paint roller frame according to the present invention.

FIG. 1A is an exploded perspective view of a conventional 5-gallon paint bucket filled with more than 3 gallons of paint where the paint roller frame resting on the grid has a hook according to the present invention.

FIG. 1B is an exploded perspective view of the same bucket where the conventional paint roller frame is resting on the grid.

FIG. 2 is a cross sectional view of the locking sleeve along line 2-2 of FIG. 1.

FIG. 3 is a cross sectional view of the roller cage through line 3-3 of FIG. 1.

FIG. 3A is a fragmentary cross sectional view along line 3A-3A of FIG. 1 showing how the stopper in the “ON” mode prevents screwing and unscrewing.

FIG. 4 is a fragmentary top plan view of the roller cage shown in FIG. 1 when the roller cage is adjusted for the smallest possible roller sleeve length it can work with.

FIG. 5 is a fragmentary cross sectional view of the connecting tube through line 5-5 of FIG. 4.

FIG. 6 is a cross sectional view of the shaft through line 6-6 of FIG. 1 with a fragmentary plan view of the preferred embodiment of the attached hook.

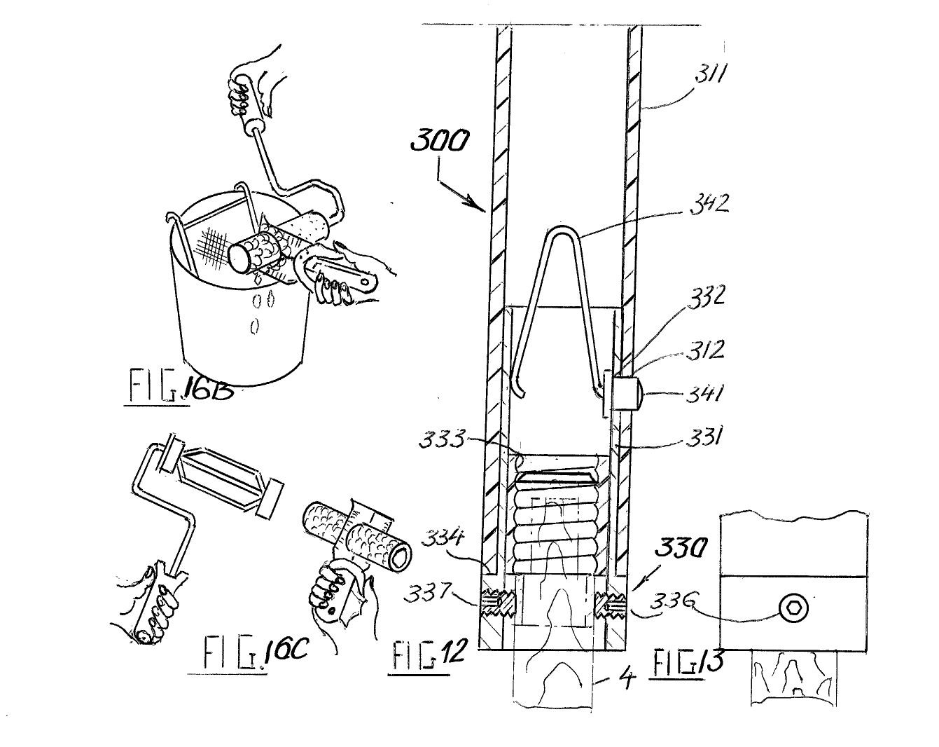

FIG. 7 is a cross sectional view of the shaft along line 7-7 of FIG. 1 that shows a plastic sheathing around the shaft.

FIG. 8 is a fragmentary cross sectional view of the outer portion of the roller cage assembly along line 8-8 showing how the clip fixes the Allen key.

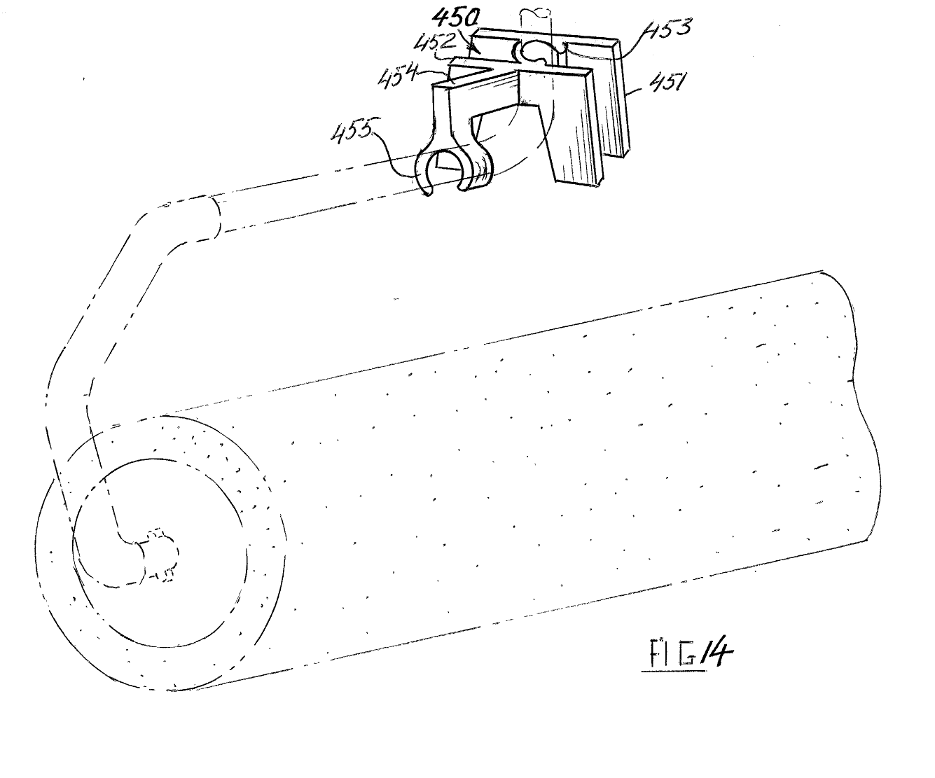

FIG. 9 is a cross sectional view of the hook permanently attached to the shaft along line 9-9 of FIG. 10.

FIG. 10 is a cross sectional view of the roller frame handle with a portion of the preferred embodiment of the adapter according to the present invention attached to the handle and represents a continuation of FIG. 1.

FIG. 11 is a side elevational view of the roller frame handle with a portion of the adapter attached to the handle.

FIG. 12 is a cross sectional view of the remaining portion of the preferred embodiment of the adapter according to the present invention with a pole extension attached to it and represents a continuation of FIG. 10.

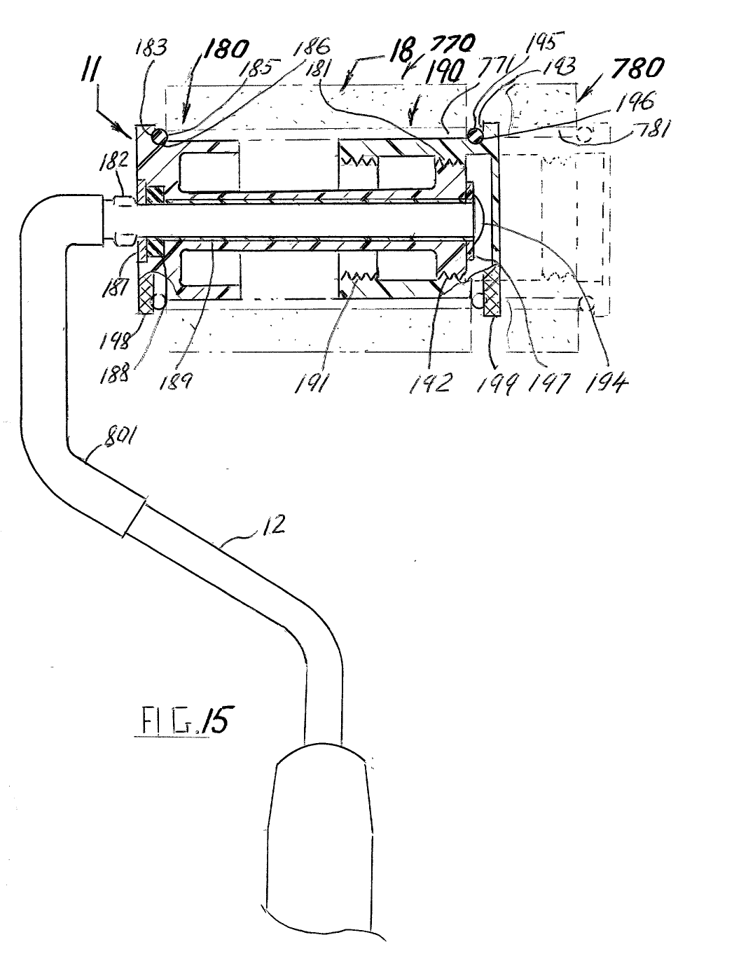

FIG. 13 is a fragmentary side elevational view of the portion of the adapter shown in FIG. 12.

FIG. 14 is an exploded perspective view of the attachable hook.

FIG. 15 is a fragmentary side cross sectional view of the second preferred embodiment of the paint roller frame according to the present invention.

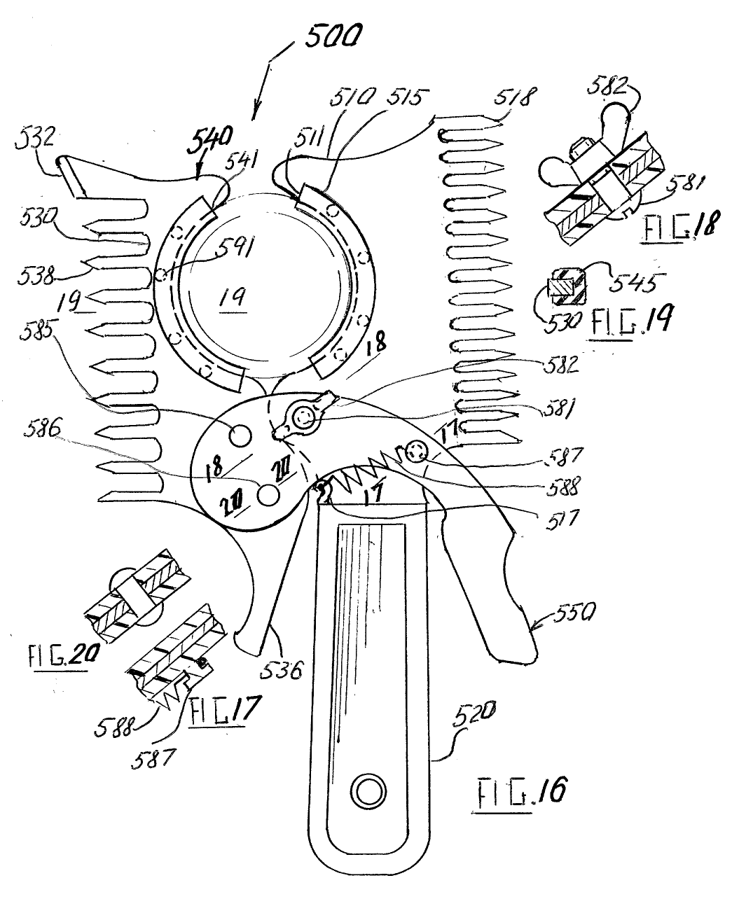

FIG. 16 is a plan view of the preferred embodiment of the multi-purpose painter tool according to the present invention.

FIG. 16A is an exploded perspective view of a paint roller frame with the paint roller sleeve embraced by the multi-purpose tool.

FIG. 16B shows how the multi-purpose tool is used to extract paint from a roller sleeve before taking it off a roller cage.

FIG. 16C shows how the multi-purpose tool is used to take a roller sleeve off a conventional roller cage.

FIG. 17 is an enlarged cross sectional view of the multi-purpose painter tool along line 17-17 of FIG. 16 showing how the spring 588 is attached to the protrusion 587.

FIG. 18 is an enlarged fragmentary cross sectional view of the multi-purpose painter tool along line 18-18 of FIG. 16 that shows the wing nut 582.

FIG. 19 is a fragmentary cross sectional view of the multi-purpose painter tool along line 19-19 of FIG. 16.

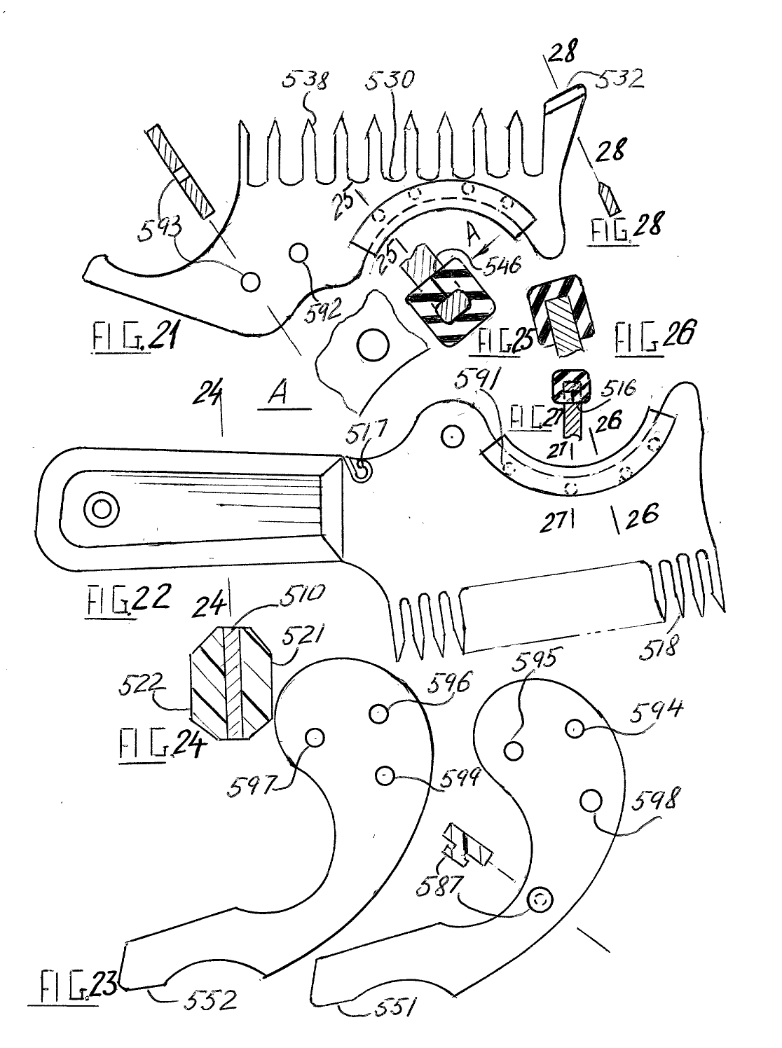

FIG. 20 is an enlarged fragmentary cross sectional view of the multi-purpose painter tool along line 20-20 of FIG. 16.

FIG. 21 is a plan view of the roller-handling member with the widely spaced comb.

FIG. 22 is a plan view of the roller-handling member with the closely spaced comb combined with a tool handle.

FIG. 23 is a plan view of two squeeze-control handles.

FIG. 24 is a cross sectional view of the multi-purpose painter tool along line 24-24 of FIG. 22.

FIG. 25 is an enlarged fragmentary cross sectional view of the multi-purpose painter tool along line 25-25 of FIG. 21.

FIG. 26 is an enlarged fragmentary cross sectional view of the multi-purpose painter tool along line 26-26 of FIG. 22.

FIG. 27 is a fragmentary cross sectional view of the multi-purpose painter tool along line 27-27 of FIG. 22.

FIG. 28 is a cross sectional view of the crack widening tooth along line 28-28 of FIG. 21.

FIG. 29 is a perspective view of the bucket organizer according to the present invention with the brush and tools container attached to it.

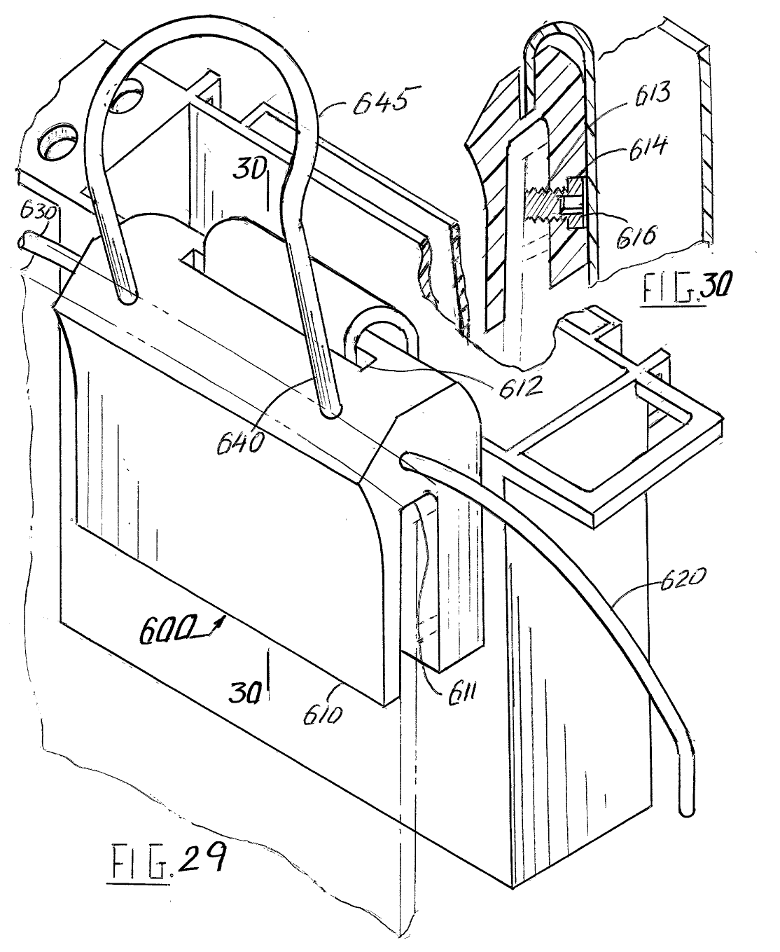

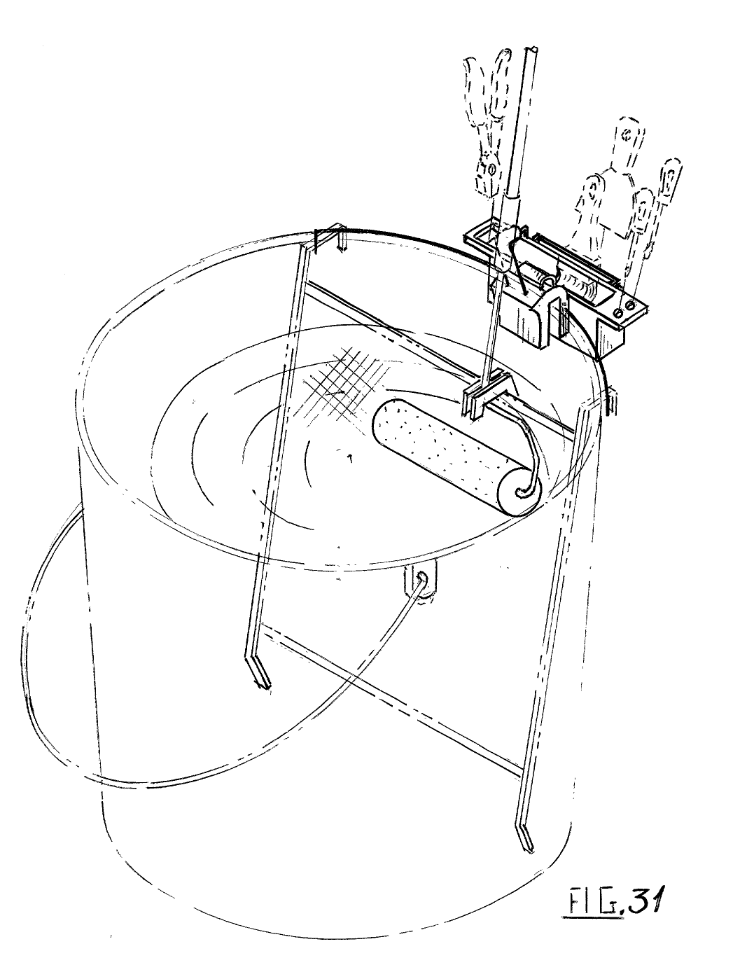

FIG. 30 is a fragmentary cross sectional view of the bucket organizer along line 30-30 of FIG. 29.

FIG. 31 illustrates how the paint bucket organizer is used with the bucket.

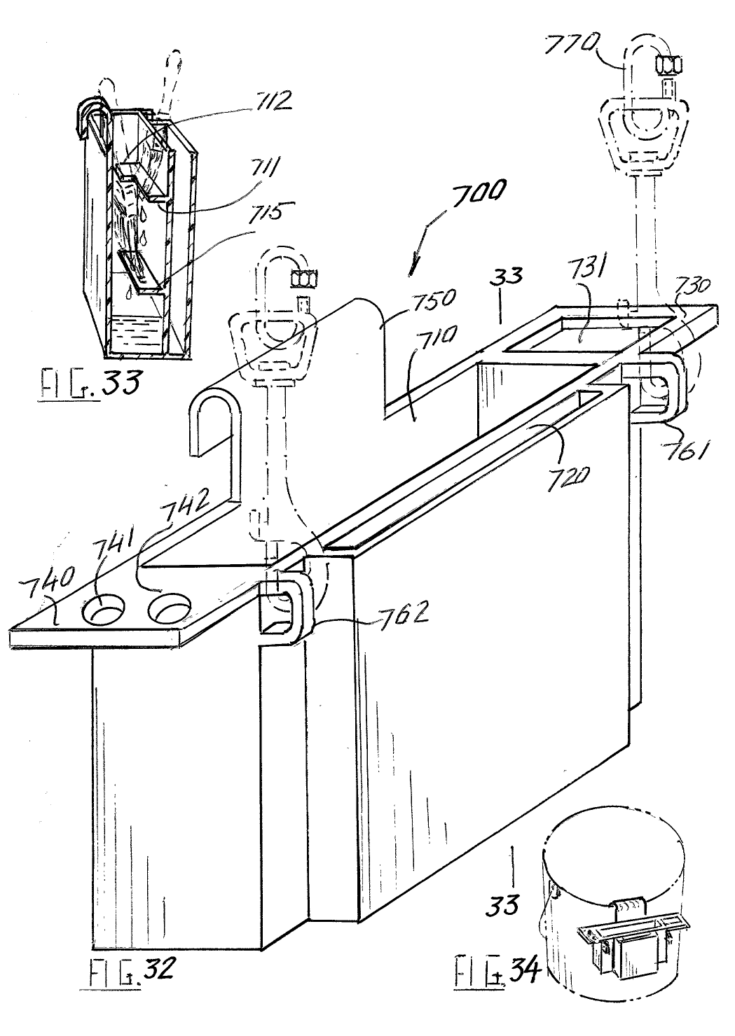

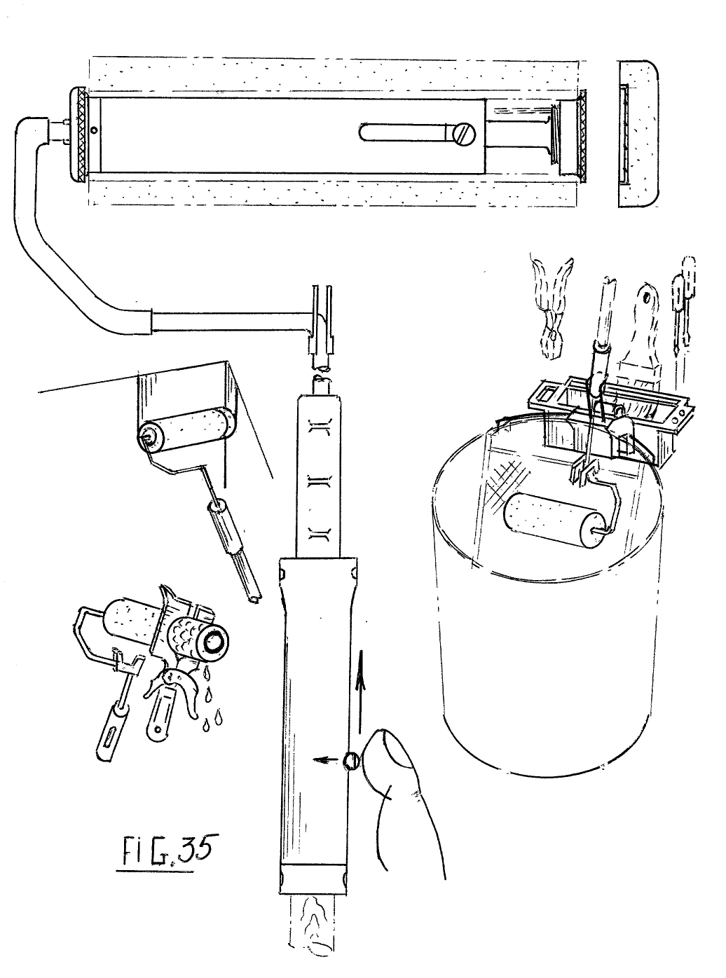

FIG. 32 is a perspective view of the brush and tools container according to the present invention.

FIG. 33 is a reduced perspective cross sectional view of the brush and tools container along line 33-33 of FIG. 32.

FIG. 34 shows the tool and brush container that is placed directly on a paint bucket.

FIG. 35 shows the paint roller frame and all the accessories according to the present invention.

### DESCRIPTION OF THE PREFERRED EMBODIMENT

Preferred embodiments of the present invention may be best illustrated by referring to the attached figures. Shown in FIG. 1 is the first preferred embodiment 1 of a paint roller frame according to the present invention. It has the leak-proof roller cage 8 adjustable to two standard paint roller sleeve lengths and any intermediate length, the roller cage stopper 160, the hook 400 to hang the paint roller frame on a grid, the shaft 2 that is covered with a plastic sheathing 800, an improved shape of the shaft, and the clip-on end wig 700.

The paint roller frame 1 in accordance with this invention comprises a shaft 2, which may, for example, be made from a heavy wire bent to shape. Suitably secured to the handle portion 175 of the shaft is a conventional handle.

Rotatably mounted on the shaft 2 is a roller cage assembly 8. It can be used for two standard roller sleeve sizes, for example, 7″ and 9″, and, if needed, any intermediate size. The cage assembly 8 comprises a bearing portion 110 with a male thread 141 on its outer end and an outer portion 150 with a mating female thread 159. The outer portion can be screwed to the bearing portion and unscrewed when it is needed.

The bearing portion for this design is an assembly that comprises an inner bearing 120 and an outer bearing 140, which are connected by a tube 130. The tube also serves as a support for a paint roller sleeve 790 that is shown in ghost outline. Unlike conventional roller cage assemblies where roller sleeve supporting means are also used to retain the sleeve on the cage, the supporting tube 130 is not frictionally engaged with the roller sleeve core 791 and does not prevent the sleeve from axial sliding. As a result, the paint roller sleeve can be effortlessly taken from the supporting tube 130 unless any retaining means are engaged.

The roller sleeve core 791 is fixed on the roller cage only because it is trapped between an annular face 111 of the inner bearing 120 and an outer annular face 151 of the outer portion 150. The outer portion 150 can be removed to permit replacement of the roller sleeve. After the paint roller sleeve is replaced, the outer portion 150 must be urged against the paint roller sleeve core to tightly squeeze the sleeve. Two resilient washers 115 and 155 are placed between the core 791 and the annular faces 111 and 151 to improve the sealing of the roller cage assembly's interior and completely inhibit paint flow inside the roller cage assembly along the core interior surface. The washers' round shape in cross section is ideal to provide a perfect seal of the core's interior and easily create a reactive force that would increase friction in the tread connection and eliminate the risk of occasional unscrewing of the outer portion 150. The squeeze is controlled by the painter and requires a reasonable judgment. The inner bearing 120 and the outer portion 150 have recesses 126 and 156 near faces 111 and 151 to better retain washers 115 and 155, correspondingly.

The roller cage assembly 8 is retained on the shaft 2 by a locking sleeve 121 and two protrusions 176 located behind a stopper 160. The locking sleeve 121 is secured in its positions on the shaft 2 with the help of headless screws 122 and 123. FIG. 2 shows a cross sectional view of the locking sleeve 121 taken along line 2-2 of FIG. 1. A plastic washer 124 is placed between the locking sleeve 121 and the inner bearing 120 to minimize friction. The only purpose of the safeguard washer 125 that is placed on the shaft next to the locking sleeve 121 is to prevent the roller cage from sudden falling from the shaft if the grip of screws 122 and 123 is weakened. The painter will promptly understand what happened and fix the roller cage.

The stopper 160 has two recesses 161 to accept the protrusions 176 that prevent the stopper from rotating and inward axial sliding. The locking sleeve 121 and the stopper 160 are mounted on the shaft so to allow the cage assembly 8 some room that is just enough for a free rotation of the roller cage.

The inner bearing 120 is connected to the tube 130 by two headless screws 133 and 134 that come through the threaded holes in the tube 130 to reach the bearing 120. To retain the tube 130 the screws 133 and 134 have their tops above the surface of the inner bearing 120, but below the supporting surface of the tube 130 to allow the roller sleeve be put on the roller cage. The inner bearing 120 also has an opening 116 to for the shaft 2 to put through. This opening is a usual source for paint leaking inside the roller cage in conventional paint roller frames. A washer 117 that is placed tightly in a recess of the inner bearing 120 eliminates leaking through the opening 116 along the shaft 2 while allowing free rotation of the roller cage.

The outer bearing 140 has an opening 146 to be mounted on the shaft 2. The outer bearing 140 is connected to the tube 130 by two screws 142 and 143 in the area close to its inner end. The opposite end of the outer bearing 140 has a male thread 141. The screws 142 and 143 access the bearing 140 through the slots 138 and 139. FIG. 4 shows a fragmentary top plan view of the roller cage shown in FIG. 1, and FIG. 5 is a fragmentary cross view of the roller cage through line 5-5 of FIG. 4 to better explain the shape of the slots 138 and 139 and position of the screws 142 and 143. When the bearing 140 is in such a position that the tube 130 is connected to it with the screws 142 and 143 located in the outmost inner positions of the corresponding slots as shown in FIG. 4, the roller cage is prepared for placement of the shortest paint roller sleeves it can be possibly used with. The roller cage can assembly can be adjusted to fit a longer sleeve by loosening the screws 142 and 143, pulling the bearing 140 off, and tightening the screws. The outmost outer positions of the screws 142 and 143 in the slots 138 and 139 correspond to the longest possible roller sleeve that can be used with the roller frame as shown in FIG. 1. Intermediate positions of the screws 142 and 143 can be used to accommodate any nonstandard roller sleeve length between the two standard lengths.

Bearings 120 and 140 have a greater contact surface with the shaft 2 than conventional roller cages. Bushings 119 and 149 that may be made of silicon impregnated Delrin for reduced friction with the shaft 2 are provided to make the roller sleeve rotation smoother and to increase durability of the roller cage.

The outer portion 150 has a knurl 157 on the cylinder surface of the outer annular face. The knurl creates more convenience for screwing-unscrewing of the outer portion. It also creates enough friction to securely retain a clip-on wig 700 shown in the FIG. 1. The clip-on wig 700 comprises a plastic cap 710 and a painting portion 720 that is made of a material similar to the covering of the paint roller sleeve.

Screws 122, 123, 142, and 143 have hex sockets. For the painter's convenience a Allen key 158 for their heads is mounted on the outer bearing 140 that has an opening 144 to accept the long leg of the Allen key and a clip 145 to fix its short leg (see FIG. 8).

The stopper 160 has a headless screw 166 that protrudes the body of the stopper through the threaded hole 167. The screw's top has a recess for accepting a conventional screwdriver tip. As shown in FIG. 3A, when the screw top is in a position approximately 2 mm below the surface of the stopper or lower, the stopper is in the ‘ON’ mode because the screw sinks in one of four recesses 112 in the inner bearing 120 and does not allow the roller cage assembly to rotate due to raisings 113 that cannot pass the screw 166. When the screw's top is above, on, or not deeper than approximately 1-2 mm of the level of the stopper, the screw is above the raisings 113, and the roller cage can freely rotate around the shaft: the stopper is in the ‘OFF’ mode. FIG. 1 shows the stopper in the ‘OFF’ position. FIG. 3 is an end view of the roller cage shown in FIG. 1 that includes a partial cross view through line 3-3 of FIG. 1. It shows all the recesses 112 and raisings 113. As it is clear from the FIG. 1, the recesses 112 are not deep enough to allow the screw 166 to completely pass through the threaded hole 167. When the screw 166 leans over the bottom of the recess 112, the roller cage 8 does not retrieve due to the locking sleeve 121.

As it is clear from FIG. 1, to disassemble the roller cage the assembly 8 one should:

unscrew the outer portion 150 and the screws 142, 143, 133, and 134

remove the outer bearing 140 and the tube 130

unscrew the screws 122 and 123

remove the safeguard washer 125, the locking sleeve 121, the washer 124, the inner bearing 120, and the stopper 160.

After this all the parts of the roller cage assembly are accessible for inspection and maintenance. Weary parts, for example the washer 117 in case of leaks through the opening 116, can be replaced.

Shown in FIG. 1 and FIG. 7 the plastic sheathing 800 covers a part of the shaft 2 that often touches walls while painting. It eliminates the source of dark spots that are unavoidable when painting by a conventional roller frame. The sheathing covers the shaft's portion 172 and extends up to the portion 173. FIG. 1 also shows how the intermediate portion 173 softens the traditional shape of conventional shafts that includes only the perpendicular portions 172 and 171. Such a shape provides a greater convenience and reduces wall touching by the shaft while working in narrow places.

Finally, FIG. 1 shows a sectional view of the hook 400 permanently attached to the shaft's handle portion 3. The hook comprises two generally flat symmetric parts 401 and 402 with the middle portions 403 and 404 that are arch-shaped for a better contact with the handle portion 3. FIG. 6 shows a fragmentary cross view of the shaft and the attached hook taken along line 6-6 of FIG. 1. The angle a and the dimensions W and H should be chosen to achieve a reasonable compromise between the convenience of the paint roller frame placement on the grid and the stability of the hanged paint roller frame when an extension pole is attached to the handle. FIG. 9 is a fragmentary cross view of the hook attached to the shaft along line 9-9 of FIG. 10, which represents the continuation of FIG. 1. It shows how the arcs 403 and 404 embrace the handle portion 175 of the shaft 2.

FIG. 1A shows how the hook 400 allows keeping over 3 gallons of paint in the 5-gallon paint bucket with the roller frame hanging on the grid above the paint surface. As it is clear from FIG. 1B, the paint roller sleeve sinks in paint when a conventional method is used for the same amount of paint.

FIG. 14 shows a perspective view of the attachable hook 450. It has two main parts 451 and 452 that are similar in regards to their shape and usage to the parts 401 and 402 of the hook 400. The hook clip 453 connects the parts 451 and 452 and is used to place the hook 450 on the shaft's handle portion 3. The part 452 has the wing 454 with the retaining clip 455 needed to secure the hook in the proper position on the shaft.

The first preferred embodiment of the paint roller frame shown in FIG. 1 cannot be recommended for a short sleeve roller frames because of the shape of its shaft and complexity of its roller cage assembly not justified for short paint roller sleeves. The second preferred embodiment of a paint roller frame shown in FIG. 15 is designed for short roller sleeves like 3″ or 4″ roller sleeves. Its roller cage assembly 18 has a bearing portion 180 with the male thread 181 on its outer end and the outer portion 190 with two mating female threads 191, the inner thread, and 192, the outer thread. The outer portion 190 can be screwed to the bearing 180 to grasp the paint roller sleeve between the two faces 183, the inner face, and 193, the outer face. Two resilient washers 185 and 195, which are located in the recesses 186 and 196 near the faces 183 and 193, improve the sealing of the roller cage assembly interior and completely inhibit paint flow inside the roller cage assembly along the core interior surface.

The roller cage assembly is secured in its place on the shaft 12 due to two protrusions 182 and the riveted shaft's end 194. The smooth rotation of the roller cage assembly 180 is achieved due to the long bushing 189 and two metal washers 187 and 197. A washer 188 that is placed tightly in a recess of the bearing portion 180 eliminates leaking of paint inside the roller cage assembly along the shaft 12 while allowing the free rotation. To avoid dark marks on the wall, a plastic sheathing 801 covers a part of the shaft 12 that can occasionally touch the wall.

The outer portion 190 can be screwed to the bearing portion 180 in two positions that correspond to two acceptable paint roller sleeve lengths, for example 4″ and 3″. The thread 191 is used for connection to squeeze the core 781 of the longer roller sleeve 780, while the thread 192 is utilized to grasp the core 771 of the shorter sleeve 770. Having two short threads 191 and 192 allows to faster grasp the shorter paint roller sleeve 770 after its placement on the roller cage assembly.

The roller cage assembly 18 does not have a stopper. This is a reasonable tradeoff for the simplicity of design for the roller frame that would hardly require the frequent change of paint roller sleeves. The knurl 198 on the cylinder surface of the inner annular face 183 is sufficient to retain the bearing portion 180 from rotation when the outer portion 190 is screwed on or from. The clip-on end wig 700 can be placed on the outer portion 190 with the knurl 199 the same way as it was described for the first preferred embodiment.

Shown in FIG. 16 is the preferred construction of the multi-purpose tool 500. The tool 500 has a pair of opposed roller-handling members 510 and 540. The member 510 with the comb of the more closely spaced teeth 518 extends to form the main handle 520. FIG. 24 shows that the handle 520 has the two layers 521 and 522 attached for a more convenient grasp.

The member 540 with the comb of the more widely spaced teeth 538 is made of the three parts: 530, 551, and 552, as shown in FIGS. 21 and 23. They are connected sandwich-like by the rivets 585 and 586, which come through the holes 592, 593, 594, 595, 596, and 597. FIG. 20 is a fragmentary cross sectional view along line 20-20 that shows how the parts 530, 551, and 552 are fixed together by the rivets.

The upper tooth 532 has a flat sharp edge and can be used to widen wall cracks before filling them with putty. FIG. 28 is a cross sectional view of FIG. 21 along line 28-28 that shows sharpness of the upper tooth 532 used as a crack widener.

The parts 551 and 552 form the handle 550 that is needed to squeeze the paint roller sleeve. The part 540 extends to form the handle 536 that is used to open the tool to embrace the paint roller sleeve.

The fulcrum 581 has a threaded end that rises above the surface of the member 530 to accept the wing nut 582 as shown in FIG. 18. The mutual position of the members 510 and 540 can be fixed by tightening the wing nut 582 if needed. The spring 588, which connects the hook 517 and the protrusion 587, tries to keep the tool in the closed position. FIG. 17 shows how the spring 588 is connected to the protrusion 587.

Each member 510 and 540 has the concaved arc surfaces 511 and 541 to embrace a paint roller sleeve. The rubber lips 515 and 545 on both arcs are provided to avoid damage to the sleeve core when the excessive presser is applied. The lips are fixed in their positions due to protrusions that come through the holes 591. FIGS. 19 and 26 show how the lips 515 and 545 are positioned on the arcs 541 and 511. FIGS. 25 and 27 show how the protrusions 546 and 616 come through the holes 591 to fix the lips 545 and 515.

FIGS. 16A, 16B, and 16C demonstrate some usages of the multi-purpose tool 500. FIG. 16A shows the multi-purpose tool embracing the paint roller sleeve; FIG. 16B explains how the tool is used to extract extra paint; and FIG. 16C shows its usage when taking the paint roller sleeve off the conventional roller cage.

Shown in FIGS. 10, 11, 12, and 13 is the preferred construction of the handle adapter 300 according to the current invention. The handle adapter 300 consists of the handle part 310 and the extension pole part 330, which can be telescopically engaged due to the inner tube 311 and the outer tube 331. When the extension pole part 330 is attached to the extension pole 4 and the handle part 310 is attached to the handle 3, the pole can be easily connected and disconnected with the paint roller frame. The inner tube 331 and the outer tube 311 are locked together by a detent 341 that is projecting from inside the tube 331 through the holes 332 and 312 in the inner end outer tubes. The detent 341 is mounted within the inner tube 331 on the end of the folded leaf spring 342.

The handle part 310 has the locking means to fasten the handle 3 that include the threaded end 315 that co-operates with the conventional internal thread 163 of the handle 3 and the two screws 316 and 317. After the handle part 310 is screwed to the handle 3, the annular recess 314 accepts the handle, and the screws 316 and 317 are used to secure the connection.

The extension pole part 330 has locking means to fasten the extension pole 4. After the extension pole 4 is screwed to the extension pole part 330 that has a mating female thread 333, the screws 336 and 337 are used to secure the connection.

When the roller frame must be used without the extension pole, pressing the detent 341 and pulling the inner tube 331 out of the outer tube 311 can disconnect the parts 310 and 330. The part 310 can be permanently attached to the handle 3 and the outer tube 311 can be used as an alternative handle.

To use the paint roller frame with the extension pole, the inner tube 331 must be inserted into the outer tube 311. When the end of the outer tube 311 reaches the annular face 334 on the inner tube 331, the extension pole must be rotated until the detent 341 rises through the hole 312 and locks the connection.

Shown in FIG. 10 is also the preferred embodiment of the paint roller frame handle according to the current invention. The handle 3 has the annular ring 165 located in the annular recess 164 close to the handle's end. The annular ring 165 is provided to ensure that the screws 316 and 317 would not loosen allowing the handle part 310 to unscrew. In all other respects the handle 3 is a conventional paint roller frame handle with the internal thread 163 to accept an extension pole.

The preferred embodiment of the paint bucket organizer 600 shown in FIG. 29 comprises the body 610, the slot 611 to place the bucket organizer 600 on the top of the bucket wall, and the screw 616 coming through the threaded hole 613 as it is shown in FIG. 30. The top of the screw 616 plunges in the recess 614. The screw 616 is pressed against the bucket fixing the organizer in its position. The bucket organizer also comprises the grid retainers 620 and 630 and the paint roller frame support 640. The paint roller frame support has the arch retainer 645 to place the paint roller frame handle or the extension pole on it. The slot 612 is provided to accommodate a hook of any accessory that is supposed to be hanged on the paint bucket. FIG. 31 illustrates how the paint bucket organizer can be used.

Shown in FIG. 32 is the preferred embodiment of the brush and tools container 700. As shown in FIG. 33, the container has a tank 710 that can keep small amount of paint and where a brush can be put on the shelf 715 to be above the paint (if there is too much paint and it covers the shelf 715, the brush soaks paint creating some inconvenience for the painter). The L-shaped paint scrapper 712 is useful to remove extra paint from the front and side of the brush before painting.

The hook 750 allows placing the container at a standard 5-gallon paint bucket or the bucket organizer described above. The loops 761 and 762 are used to fasten snaphooks when the painter wants to attach the container to the belt or the belt loops. The wings 730 and 740 have the holes 731, 741, and 742 to place screwdrivers and pliers. The compartment 720 is provided for a putty knife.

FIG. 34 shows how the tool and brush container can be placed on a paint bucket instead of putting it on the bucket organizer.

The paint roller frame in accordance with the present invention can be embodied in many different ways. For example, connection of a bearing portion and an outer portion can be achieved by using various connection means. The two preferred embodiments presented above were chosen for their simplicity and ability to better explain the principles of the invention. The same approach is applied to select preferred embodiments for accessories. It is obvious to those skilled in the art that many variations may be made without departing from the scope and principles of the present invention as set forth in the appended claims.

I claim:

1. A paint roller frame comprising a shaft having a handle portion fixedly secured to a handle and a roller cage assembly mounted on the opposite end of said shaft for supporting a paint roller sleeve thereon, wherein:
said roller cage assembly is generally perpendicular to said shaft's handle portion;
said roller cage assembly comprises a bearing portion and an outer portion which is removable to permit replacement of the roller sleeve;
said bearing portion is mounted on said shaft that is passing through an opening in the bearing portion;
said bearing portion has a supporting surface to support the paint roller sleeve and an annular (inner) face against which an adjacent (inner) end surface of the roller sleeve core can be urged to prevent the paint roller sleeve from axial sliding and to inhibit paint flow into the interior of the core;
said outer portion having a supporting surface to support the paint roller sleeve and an annular (outer) face against which an adjacent (outer) end surface of the roller sleeve core can be urged to prevent the paint roller sleeve from axial sliding and to inhibit paint flow into the core interior;
said bearing portion and said outer portion further comprising mating connection means having characteristics that ensure fast and tight trapping of the core and that prevent weakening of the sleeve squeezing while painting.

2. A paint roller frame as claimed in claim 1 further comprising two resilient washers adjacent to said inner and outer annular faces to significantly improve sealing of the core's interior and to create a strain that prevents unscrewing of the outer portion and, therefore, further ensures a secure sleeve squeezing during painting.

3. A paint roller frame as claimed in claim 1 where said bearing portion further comprises a washer to prevent leaks inside the roller cage assembly along the shaft through said opening in the bearing portion.

4. A paint roller frame as claimed in claim 1 where the length of said roller cage assembly is adjustable by repositioning of the roller cage parts allowing usage of the same roller frame with roller sleeves of different lengths.

5. A paint roller frame as claimed in claim 1 further comprising a roller cage stopper to keep said roller cage from rotating around the shaft without holding the roller sleeve with the hand or any tool; said stopper is used when there is a need to either connect (screw) said outer portion, or disconnect (unscrew) it; when the stopper is in the ‘OFF’ mode, the stopper does not prevent the roller cage from rotating, and the paint roller frame can be used for painting; when the stopper is in the ‘ON’ mode, it does not allow the roller cage to rotate, and the outer portion can be easier removed (unscrewed) to permit removal of the paint roller sleeve.

6. A paint roller frame as claimed in claim 1 wherein said roller cage can be removed from the shaft, disassembled for maintenance or replacement of worn parts, assembled again, and mounted on the shaft with the help of conventional tools.

7. A paint roller frame as claimed in claim 1 further comprising a clip-on end wig that can be mounted on the cylinder surface of said annular face of the outer end assembly comprising of a cap and a painting portion attached to the cap; said painting portion made of a material similar to the covering of the paint roller sleeve.

8. A hook that either can be made attachable or is permanently attached to the paint roller frame shaft and which, when attached, is located near the end of the shaft's handle portion that is close to the paint roller sleeve; the hook allows the roller frame be mounted higher on a grid (a paint rack) fastened in a paint bucket; such location of the hook keeps the roller sleeve resting above the paint in the highest possible position to let more paint be pored in the paint bucket without the paint roller sleeve soaking the paint.

9. A plastic sheathing for the portion of the shaft adjoining the roller cage assembly to eliminate dark marks on walls as a result of occasional touching walls by said portion of the shaft during painting.

10. A new shape of the roller frame shaft's portion adjoining the roller cage assembly to provide a greater convenience and reduce wall touching by the shaft while working in narrow places; said new shape smoothers the shaft's curve that connects two strait shaft segments one which is perpendicular to the roller axle and another one that is parallel to the roller axle and adjoining the handle portion of the shaft; said smothering is achieved by providing an intermediate portion of the shaft that has about 135° angle with both mutually perpendicular shaft portions.

11. A new multi-purpose painter tool comprising a pair of opposed roller-handling members that can be used for paint wiping before the paint roller sleeve is taken off the roller frame; wherein:
said members are both rotatably mounted on the same fulcrum;
said members have concaved arc surfaces which can embrace the paint roller sleeve and which in the outmost close position form an arc of about 360° with a diameter about the external diameter the external diameter of the paint roller sleeve core;
said members in the utmost open position allowing to easily embrace any roller sleeve;
said members have handles to hold said tool, open said members, and keep the members closed with a desirable gap to impose a controlled pressure on the embraced surface;
said tool can be also used for roller sleeve gripping; if no retaining means like a roller cage stopper are provided by the paint roller frame design, such gripping is needed to retain the roller cage from rotating when disconnecting (unscrewing) said removable outer portion; if a roller cage stopper exists, the tool can be used to grip the sleeve together with said removable outer portion when unscrewing it; the multi-purpose tool can be also used to remove the paint roller sleeve from the roller cage for any paint roller frame design;

12. A multi-purpose painter tool as claimed in claim 11 where each said member further comprises a comb to extract paint and clean brushes and where one said comb has a row of teeth more closely spaced than a row of teeth of another comb; more widely spaced teeth are used for preliminary brush cleaning while more closely spaced teeth are used for fine brush cleaning.

13. A multi-purpose painter tool as claimed in claim 11 where said arc surfaces further comprise lips to ensure a firm and reliable grip; said lips can have a resilient surface to minimize damage to the sleeve core.

14. A handle adapter that comprises two telescopically engaged parts with a lock mechanism one of these parts has a conventional male thread and fixture means to be firmly attached to a conventional roller frame handle while another part has a conventional female thread and fixture means to be firmly attached to a conventional extension pole; said parts when attached to correspondingly the paint roller frame and the pole and than engaged, provide a reliable and firm connection between the extension pole and the paint roller frame while allowing to instantly disconnect them and connect them back as needed.

15. A paint roller frame handle that has a special annular ring surface on its external end to provide for better engagement between said handle and locking means of an extension attached to the handle; said annular ring surface can be of uneven shape like ribbed or with notches, holes, etc.; the surface can belong to a special ring that is fixed on the handle.

16. A paint bucket organizer, that has a body, which can be firmly attached to the bucket with the help of a fixture, and accessories, which are mounted on the paint bucket organizer's body and which comprise a grid retainer and a paint roller frame support; said grid retainer does not allow the grid to slide along the paint bucket top edge changing its position in the paint bucket; said roller frame support holds the roller frame up when the paint roller frame is hanging on the grid not letting the roller frame to turn over even when an extension pole is attached to its handle.

17. An attachable brush and tools container that can keep a paint brush, some paint, and several tools that are usually periodically needed while painting; said container also comprises a hook to be attached to a paint bucket and loops to fasten snaphooks to be used attached, for example, to the painter's belt.
